(19) United States
(12) Patent Application Publication
(10) Pub. No.: US 2023/0233920 A1
(43) Pub. Date: Jul. 27, 2023

(54) Golf Putt Measurement Device

(71) Applicant: Brian Craig Heaton, Fairhope, AL (US)

(72) Inventor: Brian Craig Heaton, Fairhope, AL (US)

(21) Appl. No.: 17/582,080

(22) Filed: Jan. 24, 2022

(51) Int. Cl. A63B 69/36; A63B 37/00; G01S 7/481; G01S 17/58

(52) U.S. Cl. CPC A63B 69/3688; A63B 37/005; G01S 7/4813; G01S 17/58

(57) ABSTRACT

A description is provided herein of an apparatus comprising a golf ball having embedded electronic components that can measure how far said ball has rolled and its velocity during a putt across a putting surface. Elements of the ball fabrication are described which allow light to be transmitted to interrogation devices which respond depending on the orientation of the ball relative to external light sources. A correlation of light received at various parts of the ball provide an event signal which is interpreted by an on-board processor. Determination of current distance and speed is continuously calculated during the roll of the putted ball. Data is relayed to a secondary device capable of displaying the information to a golfer during putting practice sessions. This will help the golfer to train how hard to hit a putt so that it will roll a known distance.

### TECHNICAL FIELD

The system, devices, and methods described herein relate to the sport of golf and, in particular, the use of golf equipment during the action of putting a golf ball.

### BACKGROUND—PRIOR ART

The game of golf requires a golf ball to be hit using various clubs to advance the ball from a teeing area to putting green surface. Once the ball has been hit onto a putting green surface, a putting club is used to strike the ball so that it rolls across the putting surface toward a cup.

The goal is to have the golf ball go into the cup in as few strokes as possible. Around 40% of all the strokes taken in a round of golf involve putting; therefore, accurate putting is very important for playing well.

Successful putting requires a knowledge of how a golf ball will react on the putting surface when hit with the putter. The distance and speed that the ball will roll when hit by the putter with a certain force is learned by a golfer with practice and experience hitting putts in various conditions. Distance and speed of the rolling putt not only depend on the force of the putter strike, but also the slope of the green surface on which the ball is traveling. Furthermore, the friction generated between the ball and the putting green grass will cause the ball to continuously slow down. This friction force is directly related to the height of the putting green grass as a result of the daily mowing operations.

A golfer needs to frequently practice putting to develop a skill for putt distance and speed control. The mind and body must be trained to know how hard to strike a golf ball with the putter so that it will go a specific distance on a flat or a sloped putting surface while accommodating for variables such as friction with different grass lengths.

However, when a golfer practices putting a problem arises because the true distance the ball rolls is not accurately known. The goal is to practice putting a specific distance for a given putter strike, so it is vital to know an accurate roll distance. An estimate of the distance is typically performed by walking along the ball to target line and counting the number of steps taken. The number of steps is converted to distance in feet. This method is not very accurate, is time consuming, and encounters another problem: most putts are not straight. There is some curve or “break” to the travel path. Where the putt starts and where it ends are two points that define a straight line on the green. However, most likely a ball would not travel along that straight line path since all putting greens have varying slopes. Even if one were to measure between the start and end points with the step-off method, or more precisely with a ruler, the true distance of the travel path would not be known. A putt that travels 20 feet in a curved path may end up 15 feet from where it started. Training to hit this 15-foot putt requires the golfer to know it really should roll 20 feet to get to the intended spot. Only then can the golfer know to hit the putt with sufficient force.

Putting also requires consideration of the rolling speed of the ball. Estimated speed is mentally evaluated when selecting the correct line, or aim direction, of a putt. A putt with slower speed will tend to curve more off-line on a side-sloping putting surface than a faster putt. In some cases, a golfer will intentionally hit a putt with more speed to “take the break out” of a short putt. Consider the case of a putt which goes into the cup. How far would that putt have rolled had the cup not intercepted its path? A putt traveling too fast that misses the cup or “lips out” may keep rolling several feet. In fact, a fast putt effectively “shrinks” the effective size of the hole meaning that a more accurate putt is required with a fast putt than with a slower putt.

In the preceding information, it was shown that an accurate measurement of true roll distance and speed of a putt is important to achieve the goal of putting well. Putting is nearly half of all the strokes made in a round of golf. Various putting green conditions will be encountered that will affect putt motion. A golfer must train for these conditions and use some method for determining how far putts roll under such conditions.

Very few methods have been proposed for measuring the putt path and speed of a golf ball in practice sessions. One method consists of tracking golf ball motion with an imaging and doppler radar system (U.S. Pat. No. 10,989,791). Another proposes a system of ultrasonic frequency sound transmitters and receivers to track putt motion (Marquardt C. The SAM PuttLab: Concept and PGA Tour Data. International Journal of Sports Science & Coaching. 2007; 2(1_duppl):101-120. doi: 10.1260/174795407789705479). A third proposes an apparatus which tracks the position of a golf ball rolling on a specially constructed putting mat (US. Pat. Application 20210031083). A fourth proposes an apparatus of optical sensors that detect a golf ball as it passes in front of the sensors or interrupts a beam between a transmitter and receiver (U.S. Pat. No. 7,789,767 and US. Pat. Application 20060166724).

A need exists for a training device to help a golfer practice putting which will provide true putt roll distances and speeds accurately. The device should track the current distance and ball speed during all points of the putt, from contact until the putt goes into a cup. Such a device should be easily transported and can be easily setup for training sessions on any putting green. The proposed device should be easy to use, require no calibration steps, and not interfere with other golfers practicing at the same time. Said device would not require external sensors to be placed on or around the green. The proposed device should only require a normal putter without additional external sensors or attachments to the putter. Such a device should communicate wirelessly with a variety of commonly available “smart” devices to relay the information about the putt so that the golfer can see and understand the measured data. This device should be battery powered and allow for continuous use for the duration of typical putting practice sessions. Furthermore, the intended device should be affordable to the average golfer and be comprised of components and technology which is currently available.

### BRIEF SUMMARY OF THE INVENTION

This document describes a system for accurately measuring the roll distance and speed of a golf putt and providing this information to a golfer to use for training purposes. The system consists of a golf ball with embedded electronic components that measure light intensity at the surface of the golf ball as it rolls. Elements at specific locations on the surface and inside the ball allow light to enter interrogation components. An electrical response is generated which can be converted in real-time into the roll distance and speed of the golf ball. Accuracy is achieved even when the putt follows a curved path. This data is transmitted from inside the golf ball to a secondary device such as a smart phone. Using this system will help a golfer train how hard to hit a putt in various conditions so that it will roll a known distance at a certain speed.

### BRIEF DESCRIPTION OF THE DRAWINGS

FIG. 1 shows a cross-section of a golf ball with a core and outer covering layer.

FIG. 2 is a golf ball that has been bisected and mechanically milled to form a recessed cavity at 201, ports at 202, 203, and 204, and a groove around the perimeter of the outer layer at 205.

FIG. 3 illustrated an example layout of a printed circuit board having electronic components: light dependent resistor (LDR) at 302 and 303, microprocessor at 304, and power/reset switch at 305.

FIG. 4 shows a side view of the printed circuit board from FIG. 3. A coin cell battery, 401, is connected to the bottom of the circuit board.

FIG. 5 shows a diagram of the electrical connections between the components on the circuit board and the internal components of the microprocessor. The elements are further described in the Detailed Description section.

FIG. 6 shows the apparatus ball from FIG. 2, with the circuit board, 601, positioned inside the recessed cavity. The LDR components on the circuit board are aligned with ports 602 and 603. The power/reset switch is aligned with port 604.

FIG. 7 shows a ring, 701, positioned in the grove cut in the perimeter of the outer covering layer.

FIG. 8 shows the ball assembled, 801. The apparatus of FIG. 7 is joined with the apparatus of FIG. 2 and securely bonded together. The ring displayed at 802 seals and protects the internal components and allows light to penetrate.

FIG. 9 is an illustration of the assembled ball on a putting surface and the direction of roll indicated by the arrow.

FIG. 10 shows a screen of a smart phone application which is displaying data received from the golf ball containing electronic devices of this embodiment.

### DETAILED DESCRIPTION

The purpose of the apparatus and methods described herein proposes an advantage over the prior art. The following description presents one embodiment to accomplish the goal of the inventor. It is not meant to limit the inventor's claims to such embodiment. Other embodiments may be conceived which are obvious to a person having ordinary skill in the art.

A distinct benefit would exist with a golf ball that contains an internal apparatus to measure its roll distance and speed during a putt; and provide that information to a user during practice sessions. To be useful, the ball must have similar characteristics to a typical golf ball when struck with a putter. Such golf ball can be constructed in the manner described below.

But first, let us consider three premises which establish a framework for any such golf ball device.

First, a rolling spherical golf ball that is in contact with the surface it is rolling upon, and not sliding or skipping, will travel the length of its circumference in one revolution. Thus, the total roll distance is equal to the number of revolutions multiplied by the circumference of the ball

Secondly, a golf ball's axis of rotation will align perpendicular to the travel direction throughout the rolling motion. High-speed videography confirms that once a golf ball begins pure roll (no bouncing or skipping), the axis of rotation remains constant. Thus, even if the putt curves due to a slope on the putting surface, the axis of rotation will align with the new putt travel direction.

Lastly, we must consider the extent of conditions experienced by such a golf ball. The distance of a golf putt can vary from a few feet to over 100 feet on a large putting green. However, a look at the make percentage for PGA Tour players reveals that putts over 30 feet are made less than 7% of the time. For amateur players, statistics are not available but would be much less. It is a good assumption that most amateur golfers would practice putts they have a reasonable chance of making. Therefore, the proposed embodiment will operate optimally with a putt distance range of between 0 to 30 feet, however, other embodiments of the same scope as contained in the inventor's claims may work for longer putt distance ranges. Such an embodiment is mentioned in later parts of this section.

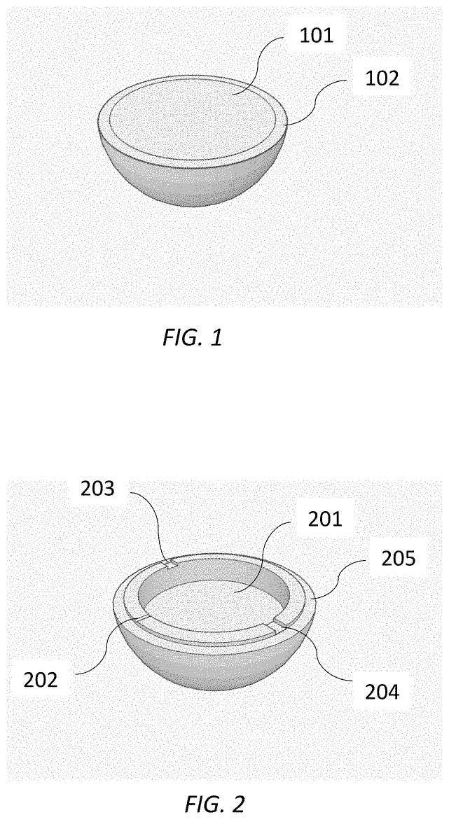

FIG. 1 shows a bisected golf ball having an internal spherical core 101 and an outer covering layer 102. Some golf balls will have additional layers between the core and outer cover. This embodiment may use a golf ball having a core with a single outer covering layer or a ball with a core and one or more intermediate “mantle” layers and an outer cover layer.

Fabrication of the apparatus of this embodiment may utilize traditional golf ball compression molding or injection molding techniques. However, in the embodiment described herein, a ball is bisected into two halves as shown in FIG. 1. Then a recessed cavity 201 is fabricated in the core which will hold a circuit board. A power switch port 202 is fabricated. Light transmission ports 203 and 204 are fabricated as well. Then groove 205 is cut in the perimeter of the outer covering to contain a light transmission ring discussed below.

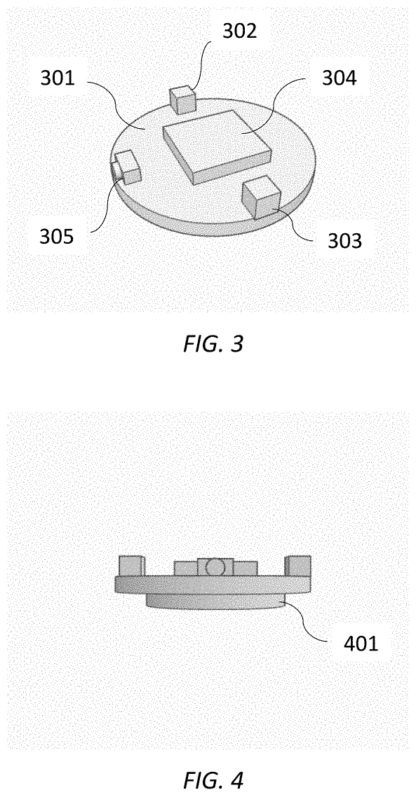

A printed electrical circuit board is fabricated. FIG. 3 shows the layout of the components on the circuit board. The board contains two light sensing elements, 302 and 303, which in this embodiment consist of light dependent resistors (LDRs). Component 304, is a microprocessor chip, however this may be optional. This microprocessor is capable of receiving analog voltage signals from the LDRs. A power/reset tactile switch, 305, is mounted on the circuit board in this embodiment. In another embodiment, the power switch may be replaced with an accelerometer or magnetic sensor which may function to wake up the device by movement or with an externally applied magnetic field.

A coin cell battery 401, which may be of such type as CR 2032, CR 2450, or another type, is connected to the circuit to provide a voltage. A reference voltage is supplied to the LDRs from the microprocessor chip. In another embodiment the reference voltage may be supplied by a separate component without the use of a microprocessor.

When light is received on the active surface of an LDR, its electrical resistance changes. A voltage drop is seen across the LDR connections due to the resistance change according to Ohm's Law (voltage=current×resistance). An input port on the microprocessor receives the output signal from the LDRs as an analog voltage. A voltage comparator component within the microprocessor produces a signal when the voltage from one LDR exceeds another LDR. In another embodiment, the voltage comparator component may be directly connected to the LDR devices without the use of a microprocessor.

The voltage comparator signal is routed to a signal counter component. In this embodiment, the counter is a pulse width modulator counter within the internal circuitry of the microprocessor. However, it is possible the signal counter component may be directly connected to the voltage comparator without the use of a microprocessor.

In this embodiment a data transmission system is comprised of a Bluetooth Low Energy (BLE) radio communication system built-in with the internal circuitry of the microprocessor. In another embodiment, the data transmission system may be some other radio communication system and it may be included in a microprocessor chip or a separate component. The microprocessor chip used in this embodiment is Infineon CYBLE-214015-01; however other processing units or microprocessors may be substituted. An antenna for the BLE system is included on the microchip component. In another embodiment an antenna device could be independent from the microprocessor unit.

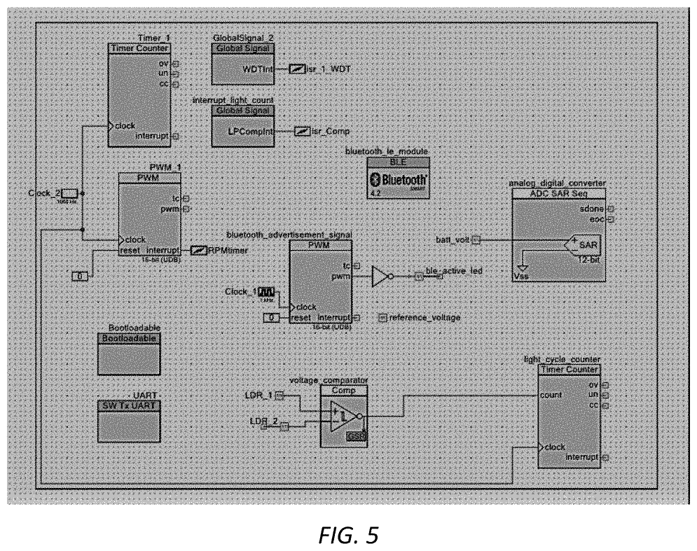

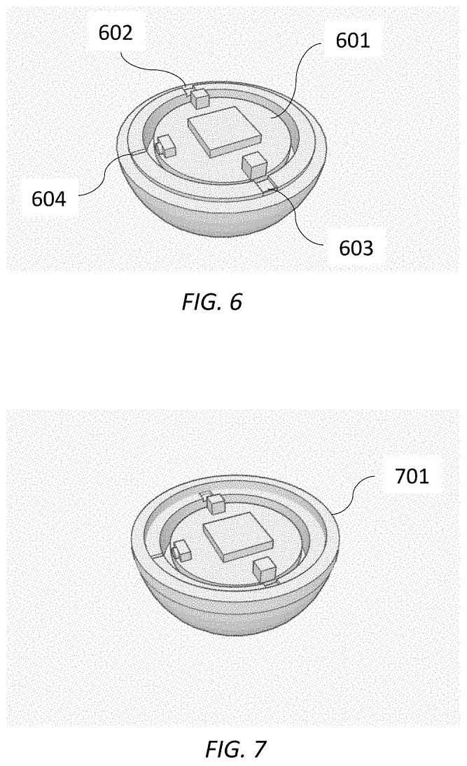

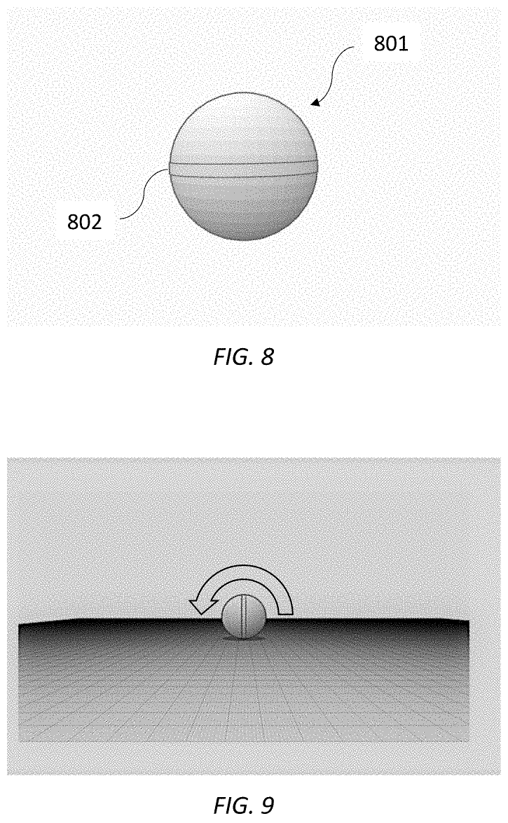

FIG. 5 shows a diagram of the components and electrical connections discussed above.

Circuit board 601 is positioned in the recessed cavity fabricated in the process discussed above. It sits at the geometric center of the ball. Ports 602 and 603 are in alignment with the LDR devices on the circuit board which allows light to penetrate from exterior sources to the sensors. Port 604 is aligned with the power/reset switch on the circuit board to allow access to the switch during operation.

Ring 701 is fabricated from a transparent or semi-transparent plastic material. This ring fits in a groove constructed around the perimeter of the ball. The outer diameter of this ring matches the diameter of the ball. The purpose of the ring is to transmit light to the LDRs via the light transmission ports while simultaneously sealing and protecting the electronic components from being damaged. In other embodiments, the light ring may be replaced by openings above the light sensitive elements. In still other embodiments, the core and external layers of a ball may be fabricated from transparent or semitransparent material which would transmit light to the light sensitive elements without the need for openings or ports.

The device is assembled by positioning the circuit board within the cavity of one ball half. Ring 701 is positioned in the grove around the perimeter.

The two halves of the ball are bonded together to form one complete ball 801. Ring 802 seals and protects the components within the ball from moisture and contaminants. This semi-transparent ring also permits light transmission to each LDR. In this embodiment a glue adhesive is used to bond the two halves of the ball together.

### Operation

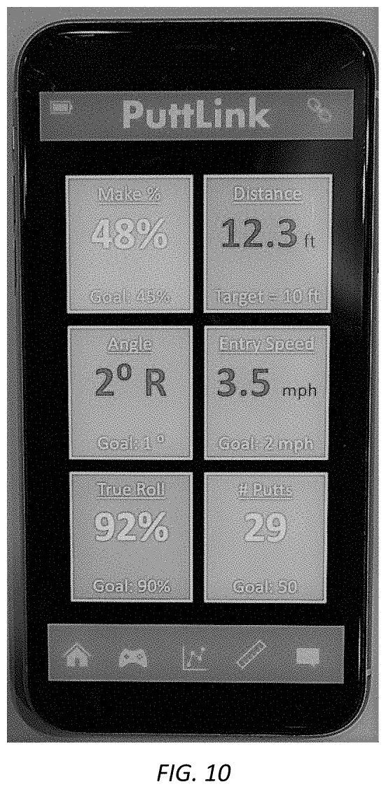

In this embodiment, light sensing LDR devices are positioned on opposite sides of the golf ball. Such an alignment allows for two advantages: the maximum amount of light variation will occur between the LDR components when the ball rolls in the plane of the LDRs. Secondly, for every ball revolution the voltage comparator will trigger a signal twice—as each LDR comes into light above the ball while the other LDR comes into shadow facing the putting surface. A depiction of this process is illustrated in FIG. 9.

After the power switch is depressed, the microprocessor in this embodiment wakes up from a hibernation state and waits for a voltage change to occur on the LDR analog input ports. A reference voltage of 2.048 volts is supplied to each LDR. As the golf ball rolls, light intensity increases and decreases to each LDR in succession. This results in a voltage drop at the LDR exposed to less light. When the voltage from LDR #1 exceeds the voltage from LDR #2, the voltage comparator sends a logic high signal to the PWM counter. The PWM counter counts the incoming logic high signals and stores the count in memory. Simultaneously, the microprocessor internal clock source registers the time frequency of the arrival of logic high signals. The count of the logic signals continues until no logic signals arrive after a set amount of time. This would indicate the ball has stopped rolling.

A count of the rise and fall of light intensity levels at the LDRs represent the number of revolutions the ball has taken. The frequency, or timing of the incoming counts, represent the rate of rotation of the ball. The number of revolutions can be converted to a distance by multiplying the circumference of the ball by the number of revolutions. Likewise, the rate of rotation can be converted to speed using the circumference length.

In this embodiment, the microprocessor calculates ball distance and speed every 250 milliseconds while the ball is in motion. This interval is governed by an internal interrupt source generated by the microprocessor. Distance and speed data is tabulated and wirelessly transmitted by the Bluetooth Low Energy (BLE) radio to a secondary device such as a smart phone, smart watch, tablet PC, or laptop computer, paired to the BLE system inside the ball. The secondary device contains a BLE system to receive the incoming data. An application program running on the secondary device displays the data on screen for the golfer to see after each putt is taken as shown in FIG. 10.

In another embodiment, the BLE system inside the golf ball may transmit an advertisement packet which contains the distance and speed data within the packet string. The advantage of such embodiment would be that any Bluetooth enabled devices near the ball could receive the advertisement packet and interpret the data. Pairing would not be necessary.

### Advantages

The invention described herein has advantages over prior art. No other known device exists or has been found in prior art which measures putt roll distance and speed without external measurement devices or sensors. All components of the proposed device required for measuring putt information are contained within a regulation-sized and regulation-weighted golf ball.

This invention will measure putt roll distance very accurately, with an estimated precision of 2-5 inches. Furthermore, it will measure distance along a curving path, giving a clear advantage to conventional techniques of putt measurement.

Another advantage of this invention is that the speed of a putt can be measured. The specific speed of putts has been an unknown quantity to the typical golfer except for rough quantifications such as “firm” or “slow.” Only very expensive radar or laboratory calibrated devices could offer insight into putt speed in the past.

Use of light sensitive elements such as LDR offers the advantage of very fast response time. Response time of LDR components is short enough to relay a signal within the timeframe of a golf putt. For a 10-foot putt, the roll rate of a putt could be as high as 5000 degrees/second. The inventor chose light as the sensing parameter because of the advantage of fast response.

The method of using two light sensitive elements combined with a voltage comparator offers a unique advantage. Golf putting can be practiced outdoors in full sun, or a cloudy sky. Putting can also be practiced indoors on carpet floors or putting matts. Many variations in light conditions are encountered. In the embodiment of the invention described herein, it does not matter what lighting conditions are present because the measurement only depends on relative light difference observed on opposite sides of the ball. There will always be a variation between the light and shadow side of the ball.

Some systems commonly used for motion tracking require a calibration or baseline reading to obtain accurate results. This invention has the advantage that no calibration or baseline measurement is needed.

A further advantage of the described invention is that the electrical components can be operated on a small coin cell battery for months to years. LDR sensors and BLE data transmission are low power devices compared to other possible components such as GPS receivers, gyroscopes, and others.

The use of Bluetooth data transmission offers an advantage of sending roll data in the advertisement packets. The golf ball could transmit data to any nearby device so multiple users could track the motion of one or multiple balls. Or the device could be operated in pairing mode which establishes a one ball, one device communication. With the advertisement packet concept, someone could walk up to a ball that had been rolled very far and read the roll distance or other data from the advertising packet.

Finally, the invention has the advantage of being portable and easily transported. The golf ball can be used at any location on a putting green without requiring setup of external systems. Almost any golfer will already be carrying a golf ball and a smart phone. This device needs no further equipment than what is already being carried.

I claim:

1. An apparatus composed a golf ball comprising:
a. a light sensing element,
b. a signal interrogation system
c. a data transmission system,
d. a power supply,
e. a light transmission means for allowing light to strike the light sensing element,
whereby the roll distance and speed of said ball along a straight or curved path across a putting surface can be measured.

2. The apparatus of claim 1, wherein one or more additional light sensing elements may be incorporated into said apparatus.

3. The apparatus of claim 1, wherein said light sensing element or elements may consist of resistors, diodes, transistors, or optical switches which exhibit an electrical response, including a change in resistance, or voltage, or switch state, in the presence of electromagnetic radiation in the visible, infrared, or ultraviolet spectrum.

4. The apparatus of claim 1, wherein said light transmission means may include a transparent or semi-transparent material within the core or outer layers of said golf ball, or may include an opening, or light transmitting feature, so that light may pass to said light sensing element or elements from external light sources.

5. The apparatus of claim 1, wherein said light sensing element or elements is connected electronically to said signal interrogation system which, by means of interrogation of electrical response of said light sensing element or elements, may detect the variations of light intensity cycles for a given time span while said golf ball is rolling across a putting surface.

6. The apparatus of claim 1, wherein said signal interrogation system converts said detection of variation of light intensity levels to the number of revolutions, per a given time span, of said golf ball rolling across a putting surface.

7. The apparatus of claim 1, wherein said signal interrogation system may consist of a voltage comparator component or a microprocessor containing a voltage comparator component which produces a response when a signal changes from said light element or elements.

8. The apparatus of claim 1, wherein said data transmission system consists of a Bluetooth Low Energy device as a separate component or included within another component.

9. The apparatus of claim 1, wherein said data transmission system transmits information to a secondary device such as a cellular phone, smart watch, handheld or tablet device, or computer.

10. The apparatus of claim 1, wherein said power supply is a coin cell battery or other type of battery and may have the capability of being recharged by direct connection between the battery and a charging unit or a wireless charging system.

11. A method for determination of the roll distance and speed of a golf ball rolling across a putting surface using a light sensing element within a golf ball, said method comprising:
a. providing said golf ball with a light sensing element that measures variation of light intensity;
b. providing a light transmission means within the core or outer layer or layers of said golf ball;
c. providing said golf ball with a system to interrogate said light sensing element;
d. providing said golf ball with a data transmission system to transmit data to and from the said golf ball to a secondary device.

12. The method of claim 11, further compromising interrogating said light elements with a voltage comparator device that produces a response when a signal changes from said light sensing element or elements.

13. The method of claim 11, further compromising calculating, by means of interrogating electrical response of said light sensing element, the number of revolutions made by said golf ball rolling across a putting surface.

14. The method of claim 11, further compromising calculating the roll distance of said golf ball across a putting surface by multiplication of the length of circumference of said golf ball by the number of revolutions.

15. The method of claim 11, further compromising calculating a distance of curvature or “break” of a putt rolling across a putting surface.

16. The method of claim 11, further compromising calculating the speed of said golf ball by means of measuring roll distance during a specific time interval.

17. The method of claim 11, further compromising calculating the speed of said golf ball as it enters a cup existing on a putting green.

18. The method of claim 16, further compromising calculating the predicted roll distance using said speed; in particular, the distance past said cup had it not been encountered by said golf ball.

19. The method of claim 11, further compromising transmitting the data by Bluetooth Low Energy system to a secondary Bluetooth-enabled device.

20. The method of claim 11, further compromising transmitting the data in the characters of an advertising packet from a Bluetooth Low Energy system to any nearby Bluetooth-enabled devices, With this method, multiple said secondary devices could receive data from one or more said golf balls simultaneously, In addition, someone could walk up to said golf ball and interrogate the advertising packet for roll data even when the said golf ball is out of range of typical BLE systems.
